(19) United States
(12) Patent Application Publication
(10) Pub. No.: US 2025/0121312 A1
(43) Pub. Date: Apr. 17, 2025

(54) HEAT RESISTANT PAD FOR SOLDERING TOOL AIR FILTRATION ASSEMBLY

(71) Applicant: Apex Brands, Inc., Apex, NC (US)

(72) Inventors: Scott BUBLITZ, Denver, NC (US); Eric VAN FOSSEN, Huntersville, NC (US)

(21) Appl. No.: 18/912,991

(22) Filed: Oct. 11, 2024

Related U.S. Application Data
(60) Provisional application No. 63/589,428, filed on Oct. 11, 2023.

(51) Int. Cl. B01D 46/00

(52) U.S. Cl. CPC B01D 46/0091; B01D 46/0002; B01D 2221/14

(57) ABSTRACT

An air filtration assembly for filtering airborne pollutants associated with soldering may include a housing which may include an intake and an exhaust, a filter which may be disposed in the housing between the intake and the exhaust, a blower which may draw an airflow into the air filtration assembly through the intake, the filter and out the exhaust, and a heat resistant pad which may be removably operably coupled to an exterior of the housing. A top surface of the heat resistant pad may be disposed substantially parallel to a work surface on which the air filtration assembly may be disposed.

### TECHNICAL FIELD

Example embodiments generally relate to air filtration assemblies and, in particular, relate to a heat resistant pad for use with soldering tool air filtration assemblies.

### BACKGROUND

Many tasks or processes that may commonly take place in manufacturing or lab settings may generate unwanted byproducts in various forms. For example, processes involving certain materials and chemicals may create waste that may need to be dealt with appropriately either via proper disposal or cleaning. In some cases, the byproducts may be airborne and may require the use of an air filtration assembly to dispose of them accordingly. One such task that may generate airborne byproducts may be soldering. Soldering tools, which are sometimes referred to as soldering irons or soldering guns, are commonly used in electronics manufacturing and repair activities along with other crafts and industries that involve metalwork. Soldering tools are typically used to join metallic items together at a joint by melting a filler metal (i.e., solder) into the joint. A tip portion of the soldering tool may, due to operation of a heater, become hot enough to melt solder that contacts the tip portion. The act of melting the solder, and thus soldering in general, may release gas into the air that may contain volatile organic compounds (VOC's) or other chemicals.

Soldering and other related tasks may often be performed at a workstation indoors. In some cases, the workstation may be located near other workstations and sometimes within the same room. Thus, an air filtration assembly may be employed to filter the air around the workstation where the task may be taking place. In some cases, the air filtration assembly may be small enough to be disposed on the workstation proximate to the soldering tool. The soldering tool may include alternate tip portions of varying shapes and sizes that may be used for different purposes while soldering. If an operator of the soldering tool desires to switch tips during soldering, the tip coming off of the tool may be hot and the operator may seek out a location to place the tip portion when not in use.

### BRIEF SUMMARY OF SOME EXAMPLES

In an example embodiment, an air filtration assembly for filtering airborne pollutants associated with soldering may be provided. The air filtration assembly may include a housing which may include an intake and an exhaust, a filter which may be disposed in the housing between the intake and the exhaust, a blower which may draw an airflow into the air filtration assembly through the intake, the filter and out the exhaust, and a heat resistant pad which may be removably operably coupled to an exterior of the housing. A top surface of the heat resistant pad may be disposed substantially parallel to a work surface on which the air filtration assembly may be disposed.

In another example embodiment, a housing for an air filtration assembly for filtering airborne pollutants associated with soldering may be provided. The housing may include a base which may include an intake and an exhaust, a cover which may be hingedly operably coupled to the base and a heat resistant pad which may be removably operably coupled to an exterior of the housing. A top surface of the heat resistant pad may be disposed substantially parallel to a work surface on which the air filtration assembly may be disposed.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of an air filtration assembly according to an example embodiment;

FIG. 2 illustrates a perspective view of the air filtration assembly in accordance with an example embodiment;

FIG. 3 illustrates a top view of the air filtration assembly in accordance with an example embodiment;

FIG. 4 illustrates a perspective view isolating the cover of the air filtration assembly housing in accordance with an example embodiment;

FIG. 5 illustrates a perspective view isolating the heat resistant pad in accordance with an example embodiment;

FIG. 6 illustrates a perspective view of the cover with the heat resistant pad removed from the recessed portion in accordance with an example embodiment;

FIG. 7 illustrates a close up perspective view of the cover and recessed portion in accordance with an example embodiment;

FIG. 8 illustrates a perspective view of the heat resistant pad in accordance with an example embodiment; and

FIG. 9 illustrates a close up section view of the heat resistant pad and the recessed portion in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of an air filtration assembly that includes a feature for storing objects, such as soldering tool tip portions. In some cases, the air filtration assembly may include a heat resistant pad composed of a high heat resistant material to protect both the soldering tool tip portions and the surface of the object they may rest on (e.g. the work surface or the air filtration assembly housing). The heat resistant pad may be disposed on an exterior of a housing of the air filtration assembly to create more usable space on the housing and the work surface as a whole. In other words, with the air filtration assembly disposed on the work station, the space it occupies may otherwise be unable to be used for anything else besides the air filtration assembly. Thus, with the heat resistant pad disposed on the housing, the hot soldering tool tip portions may be placed onto the heat resistant pad to make use of that space and allow more space on the work station to be used for other tasks or purposes as needed by the operator. However, other strategies and features may also be contemplated as described in greater detail below.

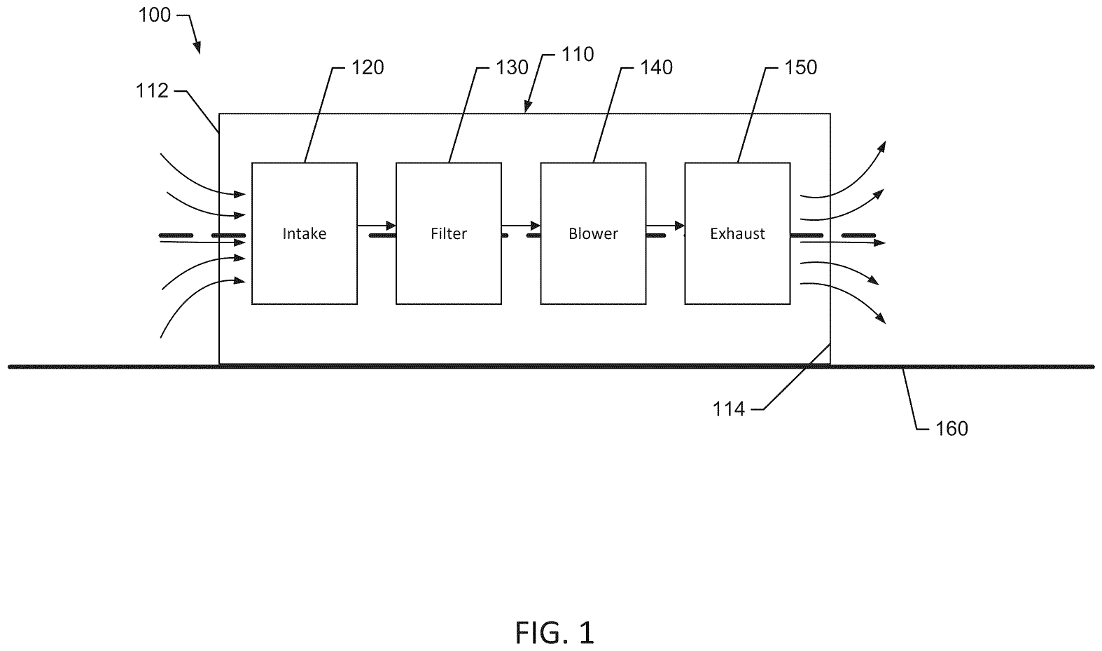

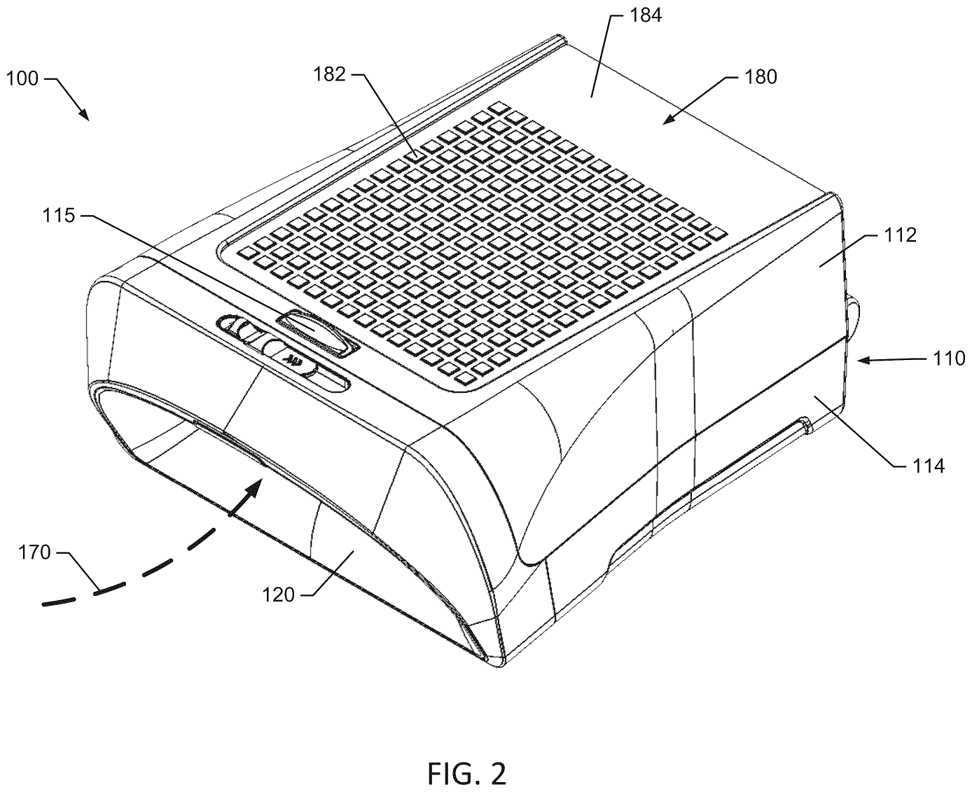

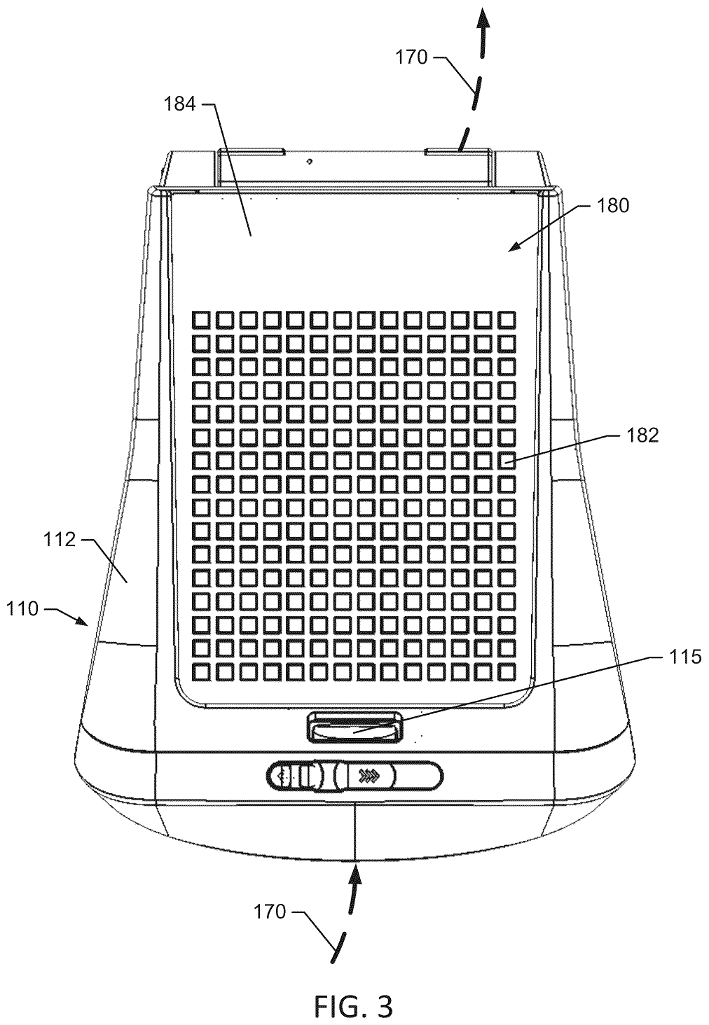

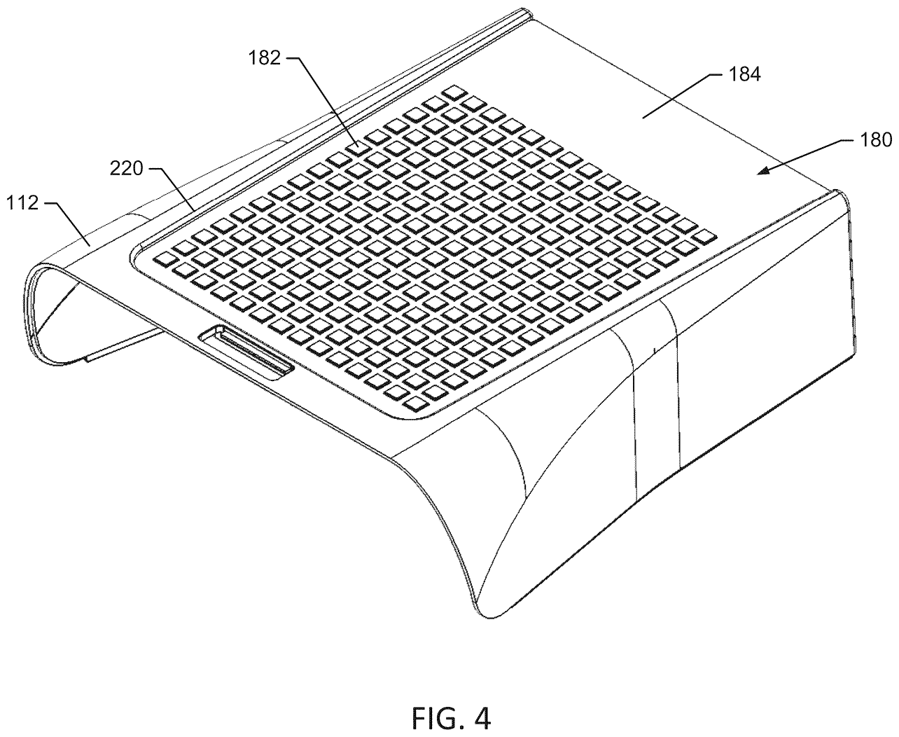

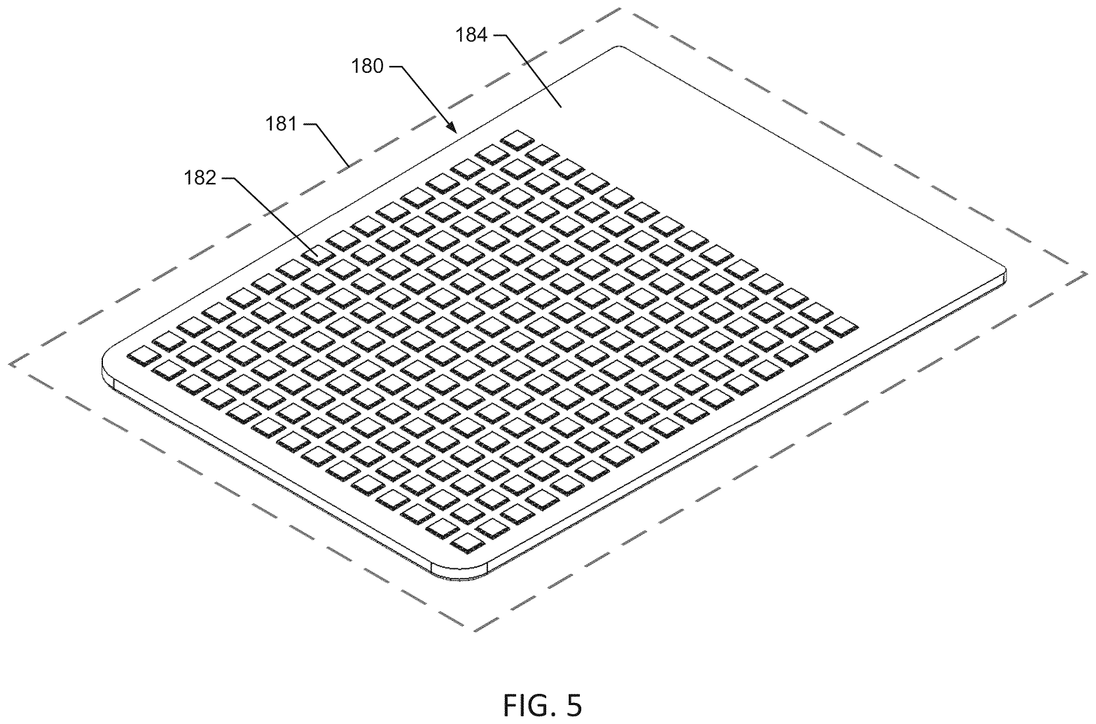

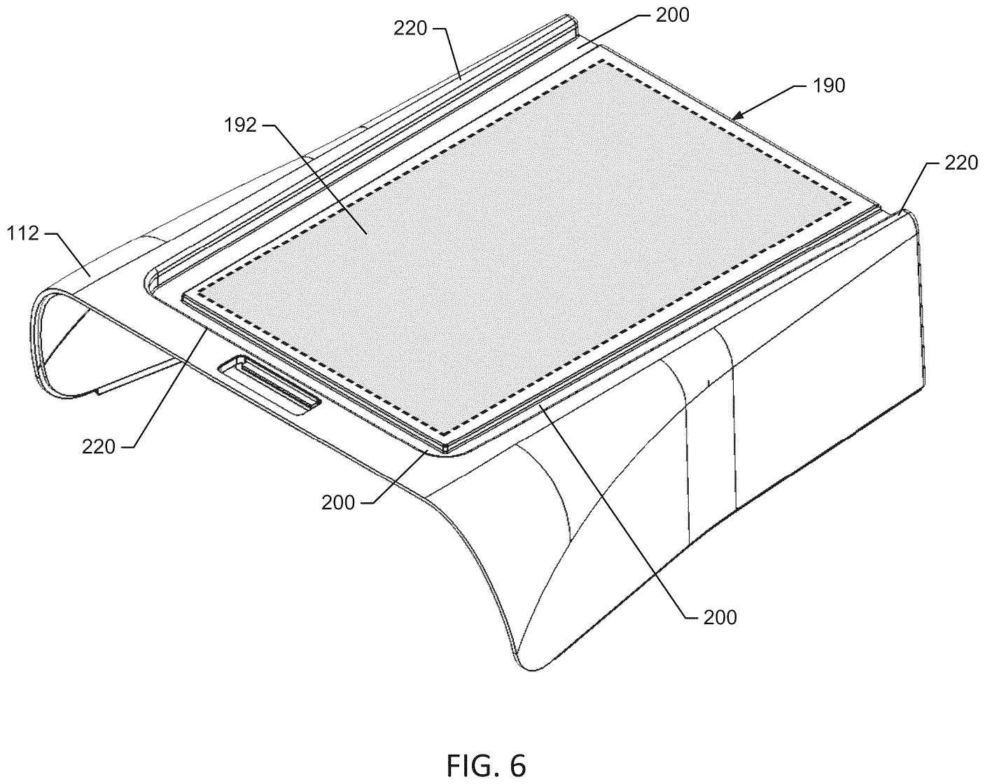

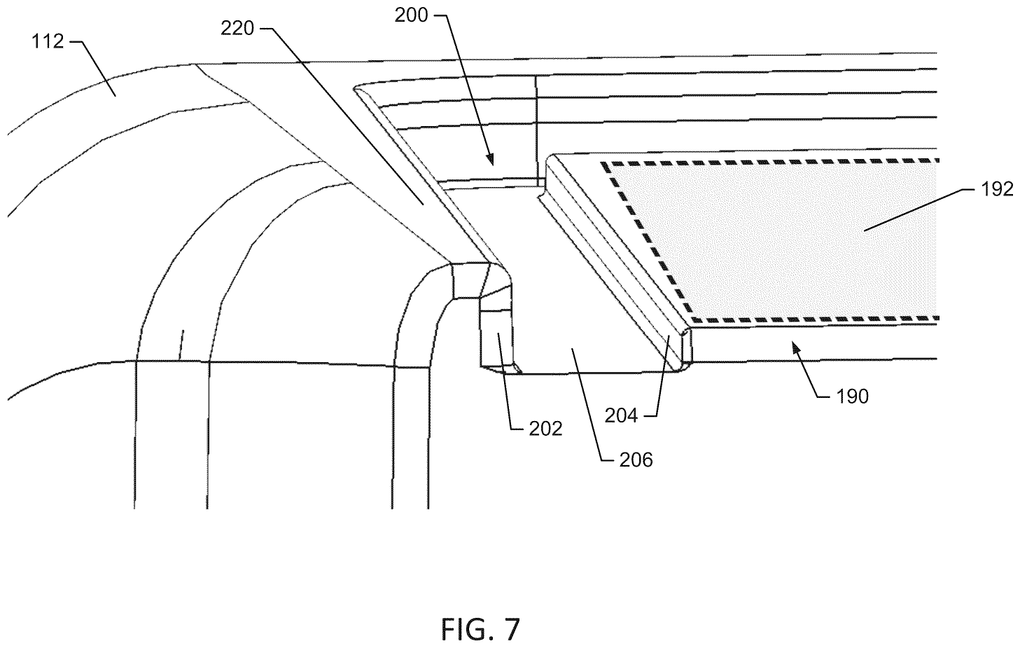

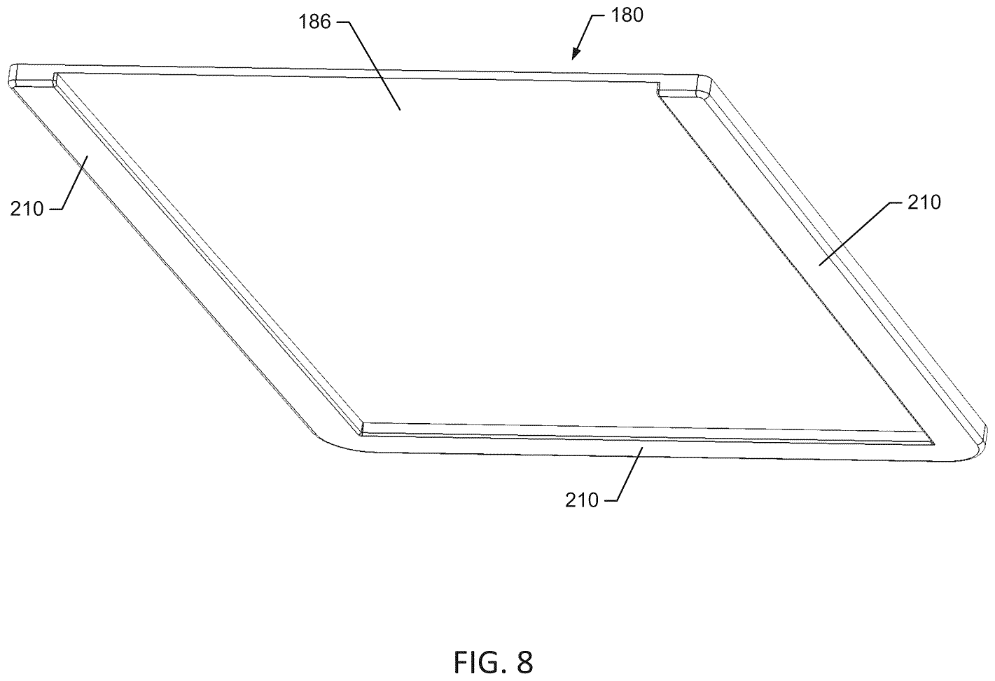

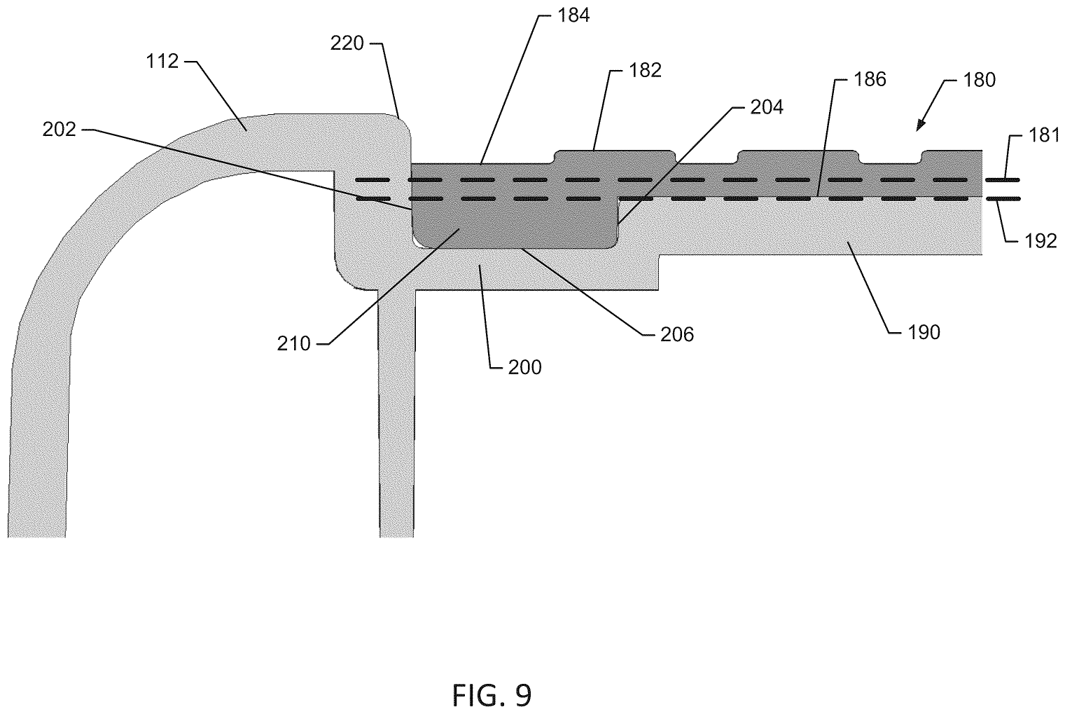

FIG. 1 illustrates a block diagram of an air filtration assembly according to an example embodiment. FIG. 2 illustrates a perspective view of the air filtration assembly in accordance with an example embodiment. FIG. 3 illustrates a top view of the air filtration assembly in accordance with an example embodiment. FIG. 4 illustrates a perspective view of the housing with part of the housing removed in accordance with an example embodiment. FIG. 5 illustrates a perspective view of a top surface of the heat resistant pad in accordance with an example embodiment. FIG. 6 illustrates a perspective view of the housing with the heat resistant pad removed in accordance with an example embodiment. FIG. 7 illustrates a close up perspective view of the housing and a recessed portion with the heat resistant pad removed in accordance with an example embodiment. FIG. 8 illustrates a perspective view of an underside of the heat resistant pad in accordance with an example embodiment. FIG. 9 illustrates a close up cross section view showing the heat resistant pad disposed in the recessed portion in accordance with an example embodiment.

The air filtration assembly 100 of FIG. 1 may include a housing 110, an intake 120, a filter 130, a blower 140, and an exhaust 150. In some cases, the housing 110 may contain, or otherwise be operably coupled to, the intake 120 and the exhaust 150, while the filter 130 and the blower 140 may all be disposed within the housing 110. The housing 110 may take on any number of shapes and sizes depending on various design constraints such as the volume of air that the air filtration assembly 100 may need to filter, or in what type of setting the air filtration assembly 100 may be used in. For example, in some cases the air filtration assembly 100 may be a relatively small assembly, and thus the housing 110 may be configured to be disposed on a desktop/workbench near a work tool, such as a soldering iron, to filter fumes and other airborne pollutants generated by the work tool. In other cases the air filtration assembly 100 may be slightly larger and thus the housing 110 may be configured to be disposed under a desk/workbench with the intake 120 being disposed near a work tool to filter fumes and other airborne pollutants generated by the work tool. In yet another case, the air filtration assembly 100 may be even larger still, and may be configured to be disposed nearby as a standalone assembly. Thus, the housing 110 may take on different shapes and/or sizes depending on the particular needs and configuration of each embodiment, which may be dictated by the environment and the particular use case of the air filtration assembly 100.

FIGS. 1 and 2 show an example embodiment of the air filtration assembly 100 in which the housing 110 may include a cover 112 and a base 114. The air filtration assembly 100 may be disposed at a work surface 160 which the base 114 may be in contact with. The cover 112 in some cases may be hingedly operably coupled to the base 114 so that the cover 112 may alternate between closed and open positions. FIGS. 2 and 3 depict the air filtration assembly 100 with the cover 112 in the closed position. In the closed position, the cover 112 may be disposed substantially on top of the base 114. In other words, the base 114 may form the bottom portion, or the foundation, of the housing 110 that may rest on the work surface 160. The cover 112 may therefore be operably coupled to a top side of the base 114 and accordingly form a top portion of the housing 110 of the air filtration assembly 100. Together, in the closed position, the cover 112 and the base 114 may enclose the filter 130 and the blower 140 within the housing 110. From the closed position, the cover 112 may pivot away from the base 114 about the hinge into the open position. When in the open position, the cover 112 may be rotated relative to the base 114 by at least approximately 90°, and may extend upright, away from the base 114. In this regard, the cover 112 in the open position may provide the operator access to the internal components of the air filtration assembly 100 (e.g. the filter 130 and blower 140) for cleaning, repair or replacement. In the closed position, the cover 112 may be secured in place to the base 114 by a locking tab 115 that may snap into place responsive to the cover 112 entering the closed position. Thus, to enter the open position, the locking tab 115 may be pressed or moved to release the cover 112 from the base 114 so that the cover 112 is able to pivot away from the base 114 accordingly.

As shown in the example embodiment of FIGS. 2 and 3, and mentioned above, the air filtration assembly 100 may be a desktop unit configured to be disposed proximate to the work tool. In some cases, the base 114 of the housing 110 may include the intake 120 and the exhaust 150 integrally formed from the base 114, rather than the housing 110 being operably coupled to separate structures for the intake 120 and the exhaust 150. In other words, the intake 120 and the exhaust 150 may be formed into the base 114 and from the material of the base 114, perhaps during a manufacturing process of the base 114. In some other embodiments, the intake 120 and the exhaust 150 may be operably coupled to the housing 110, but may be separate structures that allow for the housing 110 to be disposed perhaps further away from the work tool. Regardless of whether or not the intake 120 and exhaust 150 are formed integrally with the housing 110, an airflow 170 may enter the housing 110 of the air filtration assembly 100 through the intake 120 responsive to the operation of the blower 140. The blower 140 may be a vacuum of sorts that, when powered on, may create the airflow 170 via a motor operably coupled to a fan or other type of pump mechanism. The blower 140 may draw the airflow 170 into the air filtration assembly 100 through the intake 120 and out of the air filtration assembly 100 through the exhaust 150. As the airflow 170 exits the housing 110 via the exhaust 150, the air pressure on the exhaust-side of the filter 130 may be lower than the air pressure on the intake-side of the filter 130, creating a difference in air pressure within the air filtration assembly 100 across the filter 130. Therefore, following the principles of fluid mechanics, the airflow 170 may naturally try to move from the area of high pressure to the area of low pressure. Thus, the pressure gradient across the filter 130 may force the airflow 170 to pass from the intake 120 through the filter 130, which may filter out any airborne pollutants contained in the airflow 170, and then through the blower 140. From the blower 140 the airflow 170 may be directed to leave the air filtration assembly 100 through the exhaust 150 where the (now-filtered) airflow 170 may then reenter the immediate surrounding environment, or be directed elsewhere, responsive to having any airborne particles filtered out by the filter 130. In some cases, the filter 130 may be a high efficiency particulate air (HEPA) filter. In some other cases, different levels/forms of filtration may be desired which may necessitate different types of filters for larger or smaller airborne particulates, and even some gaseous compounds.

The desktop air filtration assembly 100 may be configured to be disposed on the work surface 160 proximate to the work tool. In some cases, in an effort to add back more usable space to the work surface 160, the cover 112 of the housing 110 may include a heat resistant pad 180 removably operably coupled thereto at an exterior of the housing 110. In this regard, the heat resistant pad 180 may serve many purposes for the operator. For example, throughout the task of soldering, the operator may need to change out a tip of the work tool depending on the specific requirements of the soldering task they are undertaking. When changing tips of the work tool, the tip that is coming off of the tool may be very hot as it may not have had time to cool down after being used. Accordingly, the heat resistant pad 180 may provide a conveniently located area to store hot work tool tips without damaging the work surface 160, the air filtration assembly 100, or the tips themselves. In another example, in some cases the operator may also be able to perform the soldering task itself upon the heat resistant pad 180 if the work surface 160 is not suitable for any reason. In any case, the heat resistant pad 180 may transform the housing 110 of the air filtration assembly 100 from an otherwise unusable space on the work surface 160 into a multi-purpose place to improve the operator's experience with the soldering task at hand.

Referring now to FIGS. 4-9, the heat resistant pad 180 may be described in further detail. FIG. 4 depicts the cover 112 removed from the base 114 with the heat resistant pad 180 disposed thereon. FIG. 5 depicts the heat resistant pad 180 removed from the cover 112. FIG. 6 illustrates the cover 112 removed from the base 114 and the heat resistant pad 180 removed from the cover 112, revealing a recessed portion 190. The cover 112, much like the base 114, may in some cases be made from a plastic material through an injection molding process. Thus, the cover 112 may largely resemble a shell having an exterior surface and an interior surface. In this regard, the cover 112 may include the recessed portion 190 formed into the exterior surface of the cover 112. In some cases, the recessed portion 190 may be integrally formed into the cover 112 during a manufacturing process (e.g. injection molding) of the cover 112.

The recessed portion 190 may be substantially planar and disposed substantially parallel to the work surface 160 on which the air filtration assembly 100 is disposed. In this regard, “substantially planar” in reference to the recessed portion 190 may refer to a majority of the recessed portion 190 lying in a recessed plane 192, with the exception of a guide channel 200, as will be discussed below in reference to FIGS. 6, 7 and 9. Similarly, the heat resistant pad 180 may also be substantially planar and disposed substantially parallel to the work surface 160 on which the air filtration assembly 100 is disposed. In this regard, “substantially planar” in reference to the heat resistant pad 180 may refer to a majority of the heat resistant pad 180 lying in a pad plane 181. The only exceptions of the heat resistant pad 180 may be a raised pattern 182 disposed on a top surface 184 of the heat resistant pad 180, and a guide rib 210 disposed on a bottom surface 186 of the heat resistant pad 180, as will be discussed below in reference to FIGS. 5, 8 and 9.

As shown in FIG. 4, the heat resistant pad 180 may be configured to operably couple to the cover 112 via the recessed portion 190. In this regard, the recessed portion 190 and the heat resistant pad 180 may both be substantially rectangular in shape, with the deviation from a completely rectangular shape being the two rounded corners on a short side of the rectangle proximate to the locking tab 115. The substantially rectangular shape of both the heat resistant pad 180 and the recessed portion 190 may maximize the amount of usable surface area occupied by the heat resistant pad 180 on the exterior surface of the cover 112 while also making the heat resistant pad 180 simpler to insert into, and remove from, the recessed portion 190. Additionally, the recessed portion 190 and the heat resistant pad 180 may be very similarly sized in both length and width, with the heat resistant pad 180 perhaps being larger than the recessed portion 190 on the order of a few millimeters in both length and width to seat the heat resistant pad 180 in the recessed portion 190 in a transition fit. In this regard, a transition fit may be defined as an engineering fit between a first and a second object, where the first object is fractionally larger than the second object into which the first object is being inserted. Thus, a light amount of force may be needed to seat the first object into the second object. In this case, the heat resistant pad 180 may be slightly larger than the recessed portion 190, and the operator may seat the heat resistant pad 180 into the recessed portion 190 by lightly pushing down on the heat resistant pad 180.

FIG. 5 shows an isolated view of the heat resistant pad 180 removed from the cover 112, and placed onto the work surface 160. In such examples, the pad plane 181, which may extend through a center of the heat resistant pad 180, may be disposed parallel to, but offset from, the work surface 160. In some cases, the heat resistant pad 180 may comprise a material that is flexible in addition to being heat resistant. In an example embodiment, the heat resistant pad 180 may be made from a high temperature silicone material. In addition to being heat resistant and flexible, the silicone material may also be slightly compressible, which may allow the heat resistant pad 180 to have some shock absorbing properties. In this regard, for example, if the operator were to drop a tip from the soldering tool onto the heat resistant pad 180, the heat resistant pad 180 may protect the housing 110 and the soldering tool tip from any impact damage resulting from the drop. The compressible nature of the silicone material may also allow for the heat resistant pad 180 to fit securely into the recessed portion 190. In this regard, the tolerances in the sizing of the heat resistant pad 180 and the recessed portion 190 may be less important because the heat resistant pad 180 may be slightly compressed into the recessed portion 190 as needed. Further still, the silicone material may have a higher coefficient of friction than the plastic material of the cover 112, and so objects placed on the heat resistant pad 180 may be more likely to remain in place as the air filtration assembly 100 operates. In some cases, the high temperature silicone material may have an intermittent temperature resistance of up to approximately 550° C. (1022° F.), which may allow the heat resistant pad 180 to come into contact with hot tip portions of the soldering tool without causing any damage to the heat resistant pad 180, the hot tips, or the housing 110 of the air filtration assembly 100. In an example embodiment, the high temperature silicone material may have a compression set of approximately 19% when tested at 180° C. for 22 hours. In this regard, the high temperature silicone may be compressed to 25% deformed for 22 hours at a temperature of 180° C. After a 30 minute recovery time, the high temperature silicone material sample may be measured, and in this case, the high temperature silicone material sample regained approximately 81% of its uncompressed thickness, hence the compression set of approximately 19%. In some cases, the high temperature silicone material may have a tear strength of approximately 20 N/mm. In an example embodiment, the high temperature silicone material may be electro-conductive and may have a volume resistivity of approximately 2 ohm-cm. In some cases, the high temperature silicone material may have a hardness rating of approximately 75 A. In an example embodiment, the high temperature silicone material may have a tensile strength of approximately 7.2 MPa, and may have 180% elongation at break. In some cases, the high temperature silicone material may have a density of approximately 1.21 g/cm³. Thus, the silicone material may provide advantages in heat resistance, shock resistance, friction and operable coupling with the recessed portion 190.

Additionally, the heat resistant pad 180 may further include a raised pattern 182 disposed on the top surface 184. The raised pattern 182 may provide the heat resistant pad 180 with some additional grip features that may help to hold objects in place on the top surface 184. In this regard, if the top surface 184 of the heat resistant pad 180 were to be perfectly planar and smooth, certain objects may more easily roll off of the heat resistant pad 180 after being placed thereon. Instead, with the inclusion of the raised pattern 182, the top surface 184 may include a plurality of raised protrusions disposed in a grid pattern that create grooves to more easily catch and hold onto objects accordingly. In other words, the grooves formed by the raised pattern 182 may be more likely to stop rounded objects from rolling off of the heat resistant pad 180. In some other cases, the raised pattern 182 may take on different shapes, spacing and orientations. That is to say, the raised pattern 182 need not be a grid pattern of raised rectangular shapes evenly dispersed across the top surface 184.

FIGS. 6-9 depict different views of the recessed portion 190 and the heat resistant pad 180 to better show the nature of their relationship and the structures that operably couple them to one another. In this regard, FIGS. 6 and 7 depict the guide channel 200 formed into part of a perimeter of the bottom of the recessed portion 190, and FIG. 8 depicts a guide rib 210 disposed on part of a perimeter of the bottom surface 186 of the heat resistant pad 180. As seen in FIG. 6, the guide channel 200 may extend around three sides of the perimeter of the recessed portion 190. The guide channel 200 may not extend around the fourth side to complete the perimeter of the recessed portion 190. This may make it easier for the operator to use the fourth side without the guide channel 200 to remove the heat resistant pad 180 from the recessed portion 190 as desired. In some cases, the guide channel 200 may extend below the recessed plane 192 and may form the lowest point of the recessed portion 190. In this regard, as seen in FIGS. 7 and 9, the guide channel 200 may have a rectangular cross section including first and second sides (202, 204) that may extend substantially parallel to one another. The first and second sides (202, 204) may be spaced apart from one another by the third side 206 which may extend perpendicularly between the first and second sides (202, 204) at a bottom edge thereof. In this regard, the third side 206 may extend parallel to the recessed plane 192 but may be offset from the recessed plane 192 by the length of the second side 204, as shown in FIGS. 7 and 9.

In some cases, the first side 202 may be longer (i.e. taller) than the second side 204. In other words, the distance measured from the third side 206 to the top of the first side 202 may be greater than the distance measured from the third side 206 to the top of the second side 204. Accordingly, the first side 202 may define a raised lip portion 220 disposed at a top of the first side 202, or in other words, at a distal end of the first side 202 from the third side 206. Like the guide channel 200, the raised lip portion 220 may also extend around three sides of a perimeter of the recessed portion 190. The raised lip portion 220 may not extend around the fourth side to make it easier for the operator to use the fourth side to remove the heat resistant pad 180 from the recessed portion 190 as desired. In both the case of the guide channel 200 and the raised lip portion 220, the fourth side may be the short length side of the rectangle disposed opposite from the rounded corners and at the edge of the cover 112. The raised lip portion 220 may serve a similar purpose as the raised pattern 182: to prevent objects from rolling off the heat resistant pad 180. As seen in FIG. 9, the exterior surface of the cover 112 may be disposed at the height of the raised lip portion 220 outside of the recessed portion 190. Thus, the top surface 184 of the heat resistant pad 180 may be disposed a distance below the raised lip portion 220 and also below the exterior surface of the cover 112. As such, the raised lip portion 220 may act as a retention wall on three sides of the heat resistant pad 180 to not let objects roll off of the heat resistant pad 180.

FIG. 8 shows the guide rib 210 disposed on the bottom surface 186 of the heat resistant pad 180. The guide rib 210 may be the complementary structure to the guide channel 200 disposed in the recessed portion 190. In this regard, similar to the guide channel 200, the guide rib 210 may also extend around three sides of a perimeter of the heat resistant pad 180. The guide rib 210 may also have a rectangular cross section, just like the guide channel 200. In this regard, the guide rib 210 may be pressed into the guide channel 200 and may operably couple to the guide channel 200 via a transition fit. In this regard, a transition fit may be defined as an engineering fit between a first and a second object, where the first object is fractionally larger than the second object into which the first object is being inserted. Thus, a light amount of force may be needed to seat the first object into the second object. In this case, the guide rib 210 may be slightly larger than the guide channel 200, and the operator may seat the guide rib 210 into the guide channel 200 by lightly pushing down on the heat resistant pad 180. The friction forces that exist between the first, second and third sides (202, 204, 206) of the guide channel 200 and the guide rib 210, responsive to the guide rib 210 being pressed into the guide channel 200, may keep the heat resistant pad 180 securely operably coupled to the recessed portion 190 so the heat resistant pad 180 doesn't lift or slide out of the recessed portion 190 at unwanted times. For instance, the guide channel 200 and the guide rib 210 may hold the heat resistant pad 180 in the recessed portion 190 responsive to the cover 112 pivoting from the closed position to the open position and while the cover 112 may remain in the open position as long as necessary.

FIG. 9 shows a cross section view of the cover 112, the recessed portion 190 and the heat resistant pad 180. As seen in FIG. 9, the guide rib 210 of the heat resistant pad 180 may seat into the guide channel 200 of the recessed portion 190 when the heat resistant pad 180 is operably coupled to the recessed portion 190. FIG. 9 also shows the pad plane 181 and the recessed plane 192. The recessed plane 192 may be offset slightly below the pad plane 181 while the heat resistant pad 180 is operably coupled to the recessed portion 190. Additionally, the raised lip portion 220 is shown to extend above the top surface 184 of the heat resistant pad 180, and also above the raised pattern 182.

In an example embodiment, the operator may desire to place the soldering station on top of the heat resistant pad 180 on the air filtration assembly 100. In this regard, the heat resistant pad 180 may help insulate the housing 110 of the air filtration assembly 100 from any heat generated and emanated by the soldering station. In some cases, the heat resistant pad 180 may be removed from the recessed portion 190 and may be placed on the work surface 160. In this regard, the operator may be able to swap tips on the work tool faster and with greater ease by having the freedom to move the heat resistant pad 180 to the most convenient place for their particular work station while the heat resistant pad 180 may still provide valuable insulation between, and protection of, both the soldering tool tips and the work surface 160. In a further example embodiment, the operator may perform the actual soldering task on the heat resistant pad 180, whether that be with the heat resistant pad 180 disposed in the recessed portion 190 or on the work surface 160. In this regard, the heat resistant pad 180 may protect the work surface 160 or the housing 110 from the soldering tool, the object being soldered, and perhaps any waste or excess solder generated from the soldering task. As mentioned above, the heat resistant pad 180 may be both substantially planar and parallel to the work surface 160, as may be the recessed portion 190. Thus, in any case, the heat resistant pad 180 may provide a flat and reliable surface on which to perform the soldering task, hold soldering tool tips, or perform other functions as needed by the operator.

Some example embodiments may provide for an air filtration assembly for filtering airborne pollutants associated with soldering. The air filtration assembly may include a housing which may include an intake and an exhaust, a filter which may be disposed in the housing between the intake and the exhaust, a blower which may draw an airflow into the air filtration assembly through the intake, the filter and out the exhaust, and a heat resistant pad which may be removably operably coupled to an exterior of the housing. A top surface of the heat resistant pad may be disposed substantially parallel to a work surface on which the air filtration assembly may be disposed.

In some cases, the air filtration assembly described above may be augmented or modified by altering individual features mentioned above or adding optional features. The augmentations or modifications may be performed in any combination and in any order. For example, in some cases, the housing may further include a base disposed on a bottom side of the housing which may contact the work surface, and a cover which may be disposed on a top side of the housing and may be hingedly operably coupled to the base. In an example embodiment, the heat resistant pad may be operably coupled to the cover. In some cases, the cover may include a recessed portion in which the heat resistant pad may be disposed. In an example embodiment, the recessed portion may include a guide channel and the heat resistant pad may include a guide rib. In some cases, the guide rib may seat inside of the guide channel via a transition fit to operably couple the heat resistant pad to the recessed portion. In an example embodiment, the heat resistant pad and the recessed portion may be substantially rectangular. In some cases, the guide channel and the guide rib may extend around three sides of a perimeter of the recessed portion and the heat resistant pad, respectively. In an example embodiment, the recessed portion may further include a raised lip that may extend around three sides of a perimeter of the recessed portion. In some cases, the top surface of the heat resistant pad may be disposed below the raised lip and also below the exterior surface of the cover. In an example embodiment, the heat resistant pad may further include a raised pattern disposed on the top surface. In some cases, the heat resistant pad may be made from high temperature silicone. In an example embodiment, the high temperature silicone may include an intermittent temperature resistance of up to approximately 550° C. In some cases, the high temperature silicone may include a hardness rating of approximately 75 A. In an example embodiment, the high temperature silicone may include a tear strength of approximately 20 N/mm.

Some example embodiments may provide for a housing for an air filtration assembly for filtering airborne pollutants associated with soldering. The housing may include a base which may include an intake and an exhaust, a cover which may be hingedly operably coupled to the base and a heat resistant pad which may be removably operably coupled to an exterior of the housing. A top surface of the heat resistant pad may be disposed substantially parallel to a work surface on which the air filtration assembly may be disposed.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. An air filtration assembly for filtering airborne pollutants associated with soldering, the air filtration assembly comprising:
a housing comprising an intake and an exhaust;
a filter disposed in the housing between the intake and the exhaust;
a blower to draw an airflow into the air filtration assembly through the intake, then the filter and out the exhaust; and
a heat resistant pad removably operably coupled to an exterior surface of the housing,
wherein a top surface of the heat resistant pad is disposed substantially parallel to a work surface on which the air filtration assembly is disposed.

2. The air filtration assembly of claim 1, wherein the housing further comprises a base disposed on a bottom side of the housing which contacts the work surface, and a cover disposed on a top side of the housing operably coupled to the base, and
wherein the heat resistant pad is operably coupled to the cover.

3. The air filtration assembly of claim 2, wherein the cover comprises a recessed portion in which the heat resistant pad is disposed.

4. The air filtration assembly of claim 3, wherein the recessed portion comprises a guide channel and the heat resistant pad comprises a guide rib, and
wherein the guide rib seats inside of the guide channel via a transition fit to operably couple the heat resistant pad to the recessed portion.

5. The air filtration assembly of claim 4, wherein the heat resistant pad and the recessed portion are substantially rectangular.

6. The air filtration assembly of claim 5, wherein the guide channel and the guide rib extend around three sides of a perimeter of the recessed portion and the heat resistant pad, respectively.

7. The air filtration assembly of claim 5, wherein the recessed portion further comprises a raised lip that extends around three sides of a perimeter of the recessed portion, and
wherein the top surface of the heat resistant pad is disposed below the raised lip and below the exterior surface.

8. The air filtration assembly of claim 1, wherein the heat resistant pad further comprises a raised pattern disposed on the top surface.

9. The air filtration assembly of claim 1, wherein the heat resistant pad is made from high temperature silicone.

10. The air filtration assembly of claim 9, wherein the high temperature silicone comprises an intermittent temperature resistance of up to approximately 550° C., a hardness rating of approximately 75 A, and a tear strength of approximately 20 N/mm.

11. A housing for an air filtration assembly for filtering airborne pollutants associated with soldering, the housing comprising:
a base comprising an intake and an exhaust;
a cover operably coupled to the base; and
a heat resistant pad removably operably coupled to an exterior surface of the housing,
wherein a top surface of the heat resistant pad is disposed substantially parallel to a work surface on which the air filtration assembly is disposed.

12. The housing of claim 11, wherein the base is disposed on a bottom side of the housing which contacts the work surface, and the cover is disposed on a top side of the housing, and
wherein the heat resistant pad is operably coupled to the cover.

13. The housing of claim 12, wherein the cover comprises a recessed portion in which the heat resistant pad is disposed.

14. The housing of claim 13, wherein the recessed portion comprises a guide channel and the heat resistant pad comprises a guide rib, and
wherein the guide rib seats inside of the guide channel via a transition fit to operably couple the heat resistant pad to the recessed portion.

15. The housing of claim 14, wherein the heat resistant pad and the recessed portion are substantially rectangular.

16. The housing of claim 15, wherein the guide channel and the guide rib extend around three sides of a perimeter of the recessed portion and the heat resistant pad, respectively.

17. The housing of claim 15, wherein the recessed portion further comprises a raised lip that extends around three sides of a perimeter of the recessed portion, and
wherein the top surface of the heat resistant pad is disposed below the raised lip and below the exterior surface.

18. The housing of claim 11, wherein the heat resistant pad further comprises a raised pattern disposed on the top surface.

19. The housing of claim 11, wherein the heat resistant pad is made from high temperature silicone.

20. The housing of claim 19, wherein the high temperature silicone comprises an intermittent temperature resistance of up to approximately 550° C., a hardness rating of approximately 75 A, and a tear strength of approximately 20 N/mm.
